(19) United States
(12) Patent Application Publication
(10) Pub. No.: US 2007/0180918 A1
(43) Pub. Date: Aug. 9, 2007

(54) Sensor nodes and self-organising sensor network formed therefrom

(76) Inventors: Michael Bahr, Munchen (DE); Dirk Becker, Ottobrunn (DE); Martin Greiner, Neukeferloh (DE); Peter Gulden, Munchen (DE); Dieter Kolb, Germering (DE); Rainer Sauerwein, Herrsching (DE); Rudolf Sollacher, Eching (DE); Martin Vossiek, Hildesheim (DE)

Correspondence Address: YOUNG & THOMPSON, 745 SOUTH 23RD STREET, 2ND FLOOR, ARLINGTON, VA, 22202, US

(21) Appl. No.: 10/591,038

(22) PCT Filed: Feb. 14, 2005
(86) PCT No.: PCT/EP05/50645

§ 371 Date: Aug. 29, 2006

(30) Foreign Application Priority Data
Mar. 10, 2004 (DE) 10 2004 011 693.8

(51) Int. Cl. G01B 5/30

(52) U.S. Cl. 73/760

(57) ABSTRACT

In a self-organizing sensor network, a number of sensor nodes organize themselves and include sensor elements, distance measuring elements and communication elements for that purpose. The sensor network is able to precisely locate individual, in particular mobile, sensor nodes.

Sensors in buildings and installations are intended to detect fires or poisonous vapors, measure material stresses in load-bearing parts of buildings or installation components, record the climatic conditions in rooms, locate sound, establish the presence of persons, or locate persons, materials or equipment.

Existing solutions can only partially fulfill these functions and typically involve a high installation, configuration and maintenance overhead. Most sensor systems are cabled, for example, as a result of which considerable time and expense is incurred for their installation. Often such systems send their data to a central computer which then performs the analysis. Centralized solutions of this type scale poorly and fail completely if the central computer goes down. In large sensor networks locating the individual sensors is also a big problem, since their position must be registered and also constantly updated. A further problem with this type of network, and one associated with considerable extra technical overhead, is the integration of mobile nodes.

Proceeding from this basis, the object underlying the invention is to enable the implementation of a sensor network which avoids the disadvantages described.

This object is achieved by the inventions set forth in the independent claims. Advantageous embodiments may be derived from the dependent claims.

Accordingly a sensor node has means for measuring distance, sensor means for measuring a sensor measurement value in addition to the distance, and means for wireless communication of the measured distance and the sensor measurement value.

The communication means are in particular means for communicating with a further sensor node.

The communication means preferably include a WLAN module.

The distance measurement means advantageously measure the distance via the transit time of a signal, more particularly a radio-frequency signal. For this purpose they include, for example, a radar module. In addition they can comprise special filtering or learning methods, in particular in the form of a Kalman filter.

A sensor network consists in particular of a plurality of sensor nodes conforming to one of the previously cited types. This enables a self-organizing sensor network to be realized for the purpose of monitoring building and installations and for navigation of maintenance and security personnel and emergency services.

The distance measurement means of the individual sensor nodes are preferably deployed and coordinated in such a way that the position of the individual sensor nodes is determined by way of the combined measurement of the distances of the sensor nodes relative to one another.

If not only the position of the sensor nodes relative to one another is to be known, but also the absolute position of the sensor nodes, then preferably at least one sensor node will have storage means for storing its absolute position. The sensor node can then be moved to multiple locations, its absolute position in each case being stored in its storage means. The sensor network then records the absolute position of the sensor node at each of these multiple locations and as a result can unambiguously establish its position in the three-dimensional space. Alternatively a plurality of sensor nodes have storage means for storing their absolute position and the plurality of sensor nodes are positioned at different positions.

The communication means of the sensor nodes are preferably set up in such a way that sensor nodes in the sensor network are able to communicate with remote sensor nodes by forwarding the communication via adjacent sensor nodes. This is accomplished in particular via position-based multi-hop routing.

Advantageously the sensor network is set up in such a way that the sensor measurement values of the sensor nodes and the positions of the sensor nodes can be queried.

The sensor network is embodied as a self-organizing sensor network that dispenses with a centralized entity.

In a method for location-resolved measurement of sensor measurement values, a sensor network conforming to one of the above-described alternatives is used for measuring the sensor measurement values. Advantageous embodiments of the method are derived analogously to the advantageous embodiments of the sensor network and vice versa.

Further features and advantages follow from the description of exemplary embodiments with reference to the drawing, in which the FIGURE shows a sensor node.

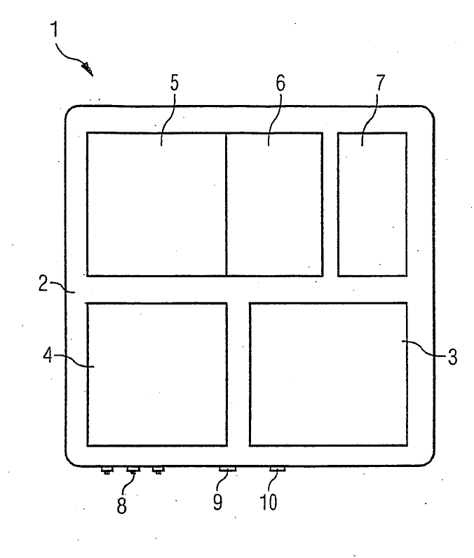

The method for location-resolved measurement of sensor measurement values and the associated self-organizing sensor network are based on wirelessly networked sensor nodes which organize their communication, positioning and sensor data processing on a largely autonomous basis. Each sensor node 1 includes, as shown in FIG. 1, a housing 2, a power supply 3, e.g. in the form of a battery or accumulator, a central processing unit 4, means 5 for communicating with one or more further sensor nodes, the communication means 5 being embodied in the form of a radio module, distance measurement means 6 in the form of a radar module and sensor means 7 for measuring a sensor measurement value in addition to the distance. The power supply 3, the central processing unit 4, the communication means 5, the distance measurement means 6 and the sensor means 7 are accommodated in the housing 2. The housing 2 and hence the sensor node 1 additionally has terminals 8 for connecting one or more antennas, a terminal 9 for connecting the voltage supply and a terminal 10 for connecting external devices for exchanging data, e.g. via Ethernet.

The communication means 5 in the form of the radio module permit the sensor node 1 to communicate with adjacent sensor nodes, for example using the WLAN standard. Remote sensor nodes can also be reached by means of position-based multi-hop routing.

The distance measurement means 6 in the form of the radar module perform measurements to determine the distance to adjacent sensor nodes. By exchanging estimated positions via the communication means 5 and using suitable filtering and/or learning methods, such as a Kalman filter for example, the sensors can establish their location in an internal coordinate system.

By inputting absolute coordinates for a plurality of sensor nodes or for one mobile sensor node at different locations by means of a connected application, the internal coordinate system can be synchronized with that of an external map of the environment.

The sensor means 7 in the form of the sensor module supply different sensor measurement values. These are used in combination with sensor measurement values of adjacent sensor nodes in order to train a local regression model which permits spatial profiles or even space-time profiles of sensor measured variables to be generated. These profiles can be queried by external applications. Said applications can be, for example, visualization methods on portable computers which are in each case connected to a sensor node.

The sensor nodes require little overhead for the installation and operation of a sensor network. The sensor network has the capability to determine the exact location of individual, in particular mobile, sensor nodes. It scales well, which is to say that it can easily be extended with additional sensor nodes and in this way can increase the coverage or the resolution. The mode of operation of the sensor network will be adversely affected to a noticeable degree only if many of the sensor nodes fail, since the communication can be switched over to other routes and the sensor information is stored in a distributed manner in the network.

1. Sensor nodes having
sensor means (7) for measuring a sensor measurement value,
means (6) for measuring distance,
means (5) for communicating.

2. The sensor nodes as claimed in claim 1,
characterized in that
the communication means (5) are means for communicating with further sensor nodes.

3. The sensor nodes as claimed in claim 1, characterized in that
the communication means (5) include a WLAN module.

4. The sensor nodes as claimed in claim 1, characterized in that
the distance measurement means (6) have means for measuring a signal transit time.

5. The sensor nodes as claimed in claim 1,
characterized in that
the distance measurement means (6) have a Kalman filter for measuring the distance.

6. A sensor network comprising a plurality of sensor nodes (1) as claimed in claim 1.

7. The sensor network as claimed in claim 6,
characterized in that
the sensor nodes (1) have means for determining position via the distance measurement means (6).

8. The sensor network as claimed in claim 6,
characterized in that
one of the sensor nodes has storage means for storing its absolute position.

9. The sensor network as claimed in claim 6,
characterized in that
the communication means (5) are set up in such a way that sensor nodes (1) in the sensor network can communicate with remote sensor nodes by forwarding the communication via adjacent sensor nodes.

10. The sensor network as claimed in claim 6, characterized in that
the sensor network is set up in such a way that the sensor measurement values of the sensor nodes (1) and the positions of the sensor nodes (1) can be queried.

11. The sensor network as claimed in claim 6,
characterized in that
the sensor network is a self-organizing sensor network.

12. A method for location-resolved measurement of sensor measurement values
characterized in that
a sensor network as claimed in claim 6 is used for measuring the sensor measurement values.

13. The sensor nodes as claimed in claim 2, characterized in that
the communication means (5) include a WLAN module.

14. The sensor nodes as claimed in claim 2, characterized in that
the distance measurement means (6) have means for measuring a signal transit time.

15. The sensor nodes as claimed in claim 2,
characterized in that
the distance measurement means (6) have a Kalman filter for measuring the distance.

16. The sensor nodes as claimed in claim 3, characterized in that
the distance measurement means (6) have means for measuring a signal transit time.

17. The sensor nodes as claimed in claim 3,
characterized in that
the distance measurement means (6) have a Kalman filter for measuring the distance.

18. The sensor nodes as claimed in claim 4,
characterized in that
the distance measurement means (6) have a Kalman filter for measuring the distance.

19. The sensor network as claimed in claim 7,
characterized in that
one of the sensor nodes has storage means for storing its absolute position.

20. The sensor network as claimed in claim 7,
characterized in that
the communication means (5) are set up in such a way that sensor nodes (1) in the sensor network can communicate with remote sensor nodes by forwarding the communication via adjacent sensor nodes.
